(19) United States
(12) Patent Application Publication
(10) Pub. No.: US 2009/0032593 A1
(43) Pub. Date: Feb. 5, 2009

(54) Smart card and smart card reader

(76) Inventor: Henrik Ljungcrantz, Linkoping (SE)

Correspondence Address: HARNESS, DICKEY & PIERCE, P.L.C., P.O. BOX 8910, RESTON, VA, 20195, US

(21) Appl. No.: 11/918,937

(22) PCT Filed: Apr. 24, 2006
(86) PCT No.: PCT/SE2006/000475

§ 371 Date: Oct. 22, 2007

(30) Foreign Application Priority Data
Apr. 25, 2005 (SE) 0500930-3

(51) Int. Cl. G06K 7/06; G06K 19/06

(52) U.S. Cl. 235/441; 235/492

(57) ABSTRACT

A smart card (1) has a card contact element (2) for establishing an electrical contact with a reader contact element of a smart card reader for reading the smart card (1). The card contact element (2) has a contact surface (3) coated with a contact layer, said contact surface (3) being arranged to be brought into contact with the reader contact element. The contact layer comprises a multiele-ment material that has a composition of at least one of a carbide or nitride described by the formula MqAyXz, where M is a transition metal or a combination of transition metals, A is a group A element or a combination of group A elements, X is carbon or nitrogen or both, and q, y and z are numbers above zero. The multi-element material further comprises at least one nanocomposite comprising single elements, binary phases, ternary phases, quaternary phases or higher order phases based on the atomic elements in the corresponding MqAyXz compound. A reader for reading a smart card (1) is also disclosed.

### TECHNICAL FIELD OF THE INVENTION

The present invention relates to a smart card having a card contact element for establishing an electrical contact with a reader contact element of a smart card reader for reading the smart card, said card contact element having a contact surface coated with a contact layer, said contact surface being arranged to be brought into contact with the reader contact element, wherein the contact layer comprises a multielement material.

The present invention also relates to a reader for reading a smart card, said reader having a reader contact element for establishing an electrical contact with a card contact element on a smart card, said reader contact element having a contact surface coated with a contact layer, said contact surface being arranged to be brought into contact with the card contact element, wherein the contact layer comprises a multielement material.

### BACKGROUND ART

Smart cards are today used in a number of applications and their use is increasing. One use is as Subscriber Identity Modules or SIM cards for mobile telephones. Another use is within the banking sector, where smart cards may replace credit cards with magnetic strips. A similar use is within the transportation sector, where smart cards may be used for paying highway tolls or as tickets in public transportation. Smart cards are also used for digital rights management in payment TV.

A smart card is often a credit card-sized plastic card having a chip on one side, but may also be smaller, e.g. reduced more or less to the size of the actual chip, such as in SIM cards.

Many of these smart cards will repeatedly be inserted into a reader for verification or for deducting an amount of money from an account associated with the smart card. The contact elements of the smart cards therefore need to have a surface that is very resistant to wear while at the same time assuring good electrical contact between the smart card and the reader. The same requirements apply to contact elements in the readers for reading the smart cards.

To achieve this, a coating containing gold is normally used. However, a disadvantage of gold is its high price. Thus, a need remains for a coating that can be used for smart cards and smart card readers and that ensures wear resistance and good electrical contact, but which is more cost efficient.

### SUMMARY OF THE INVENTION

An object of the present invention is to provide a smart card that has a contact element which is wear resistant and assures good electrical contact with a reader and which can be produced in a cost effective manner.

Another object of the present invention is to provide a smart card reader having a contact element which is wear resistant and assures good electrical contact with a smart card and which can be produced in a cost efficient manner.

According to the invention, these objects are achieved by means of a smart card according to claim 1. Preferred embodiments thereof are defined in the dependent claims 2-16.

The abovementioned objects are also achieved by means of a reader according to claim 17, preferred embodiments being defined in the dependent claims 18-24.

In the smart card of the invention, the multielement material has a composition of at least one of a carbide or nitride described by the formula M_{q}A_{y}X_{z}, where M is a transition metal or a combination of transition metals, A is a group A element or a combination of group A elements, X is carbon or nitrogen or both, and q, y and z are numbers above zero, and the multielement material further comprises at least one nanocomposite comprising single elements, binary phases, ternary phases, quaternary phases or higher order phases based on the atomic elements in the corresponding M_{q}A_{y}X_{z} compound.

The composition may for instance be M_{0.2}AX, M_{0.2}AX_{0.1}, M₄AX, or M₂AX₂.

A “nanocomposite” is a composite comprising crystals, regions or structures with a characteristic length scale above 0.1 nm and below 1000 nm.

With such a contact layer a very high wear resistance can be achieved, while assuring a good electrical contact. The cost of the multielement material used is lower than the cost of gold.

In one embodiment, the multielement material has a composition of at least one of a carbide or nitride described by the formula Mₙ₊₁AXₙ, where M is a transition metal or a combination of transition metals, A is a group A element or a combination of group A elements, X is carbon or nitrogen or both, and n is 1, 2, 3 or higher, and the multielement material further comprises at least one nanocomposite (4) comprising single elements, binary phases, ternary phases, quaternary phases or higher order phases based on the atomic elements in the corresponding Mₙ₊₁AXₙ compound. These particular forms of the multielement materials of the invention have been shown to have very good properties in view of wear resistance and electrical contact.

The nanocomposite preferably comprises at least two phases chosen from the group consisting of M-A, A-X, M-A-X, X and M-X. In this manner, the contact layer becomes particularly shock resistant and gives a particularly low contact resistance.

In one embodiment of the invention, the transition metal is titanium, X is carbon and the group A element is at least one of silicon, germanium or tin. With such a multielement material a very low contact resistance is achieved, while at the same time the wear resistance is very high.

According to a preferred embodiment of the present invention, the multielement material is Ti₃SiC₂ and the nanocomposite comprises at least one phase chosen from the group consisting of Ti—C, Si—C, Ti—Si—C, Ti—Si and C.

The nanocomposite may be at least partially in an amorphous state or a nanocrystalline state, and can have amorphous regions mixed with nanocrystalline regions.

The contact layer may also comprise a metallic layer.

The metallic layer is preferably any of gold, silver, palladium, platinum, rhodium, iridium, rhenium, molybdenum, tungsten, nickel or an alloy with at least one of the aforementioned metals.

In one embodiment, the metallic layer is any metal or metal composite, where the composite can be an oxide, carbide, nitride or boride.

In the smart card reader of the invention, the multielement material has a composition of at least one of a carbide or nitride described by the formula M_{q}A_{y}X_{z}, where M is a transition metal or a combination of transition metals, A is a group A element or a combination of group A elements, X is carbon or nitrogen or both, and q, y and z are numbers above zero, and the multielement material further comprises at least one nanocomposite comprising single elements, binary phases, ternary phases, quaternary phases or higher order phases based on the atomic elements in the corresponding M_{q}A_{y}X_{z} compound. The reader having such a contact layer is very wear resistant and ensures good electrical contact with a smart card, but the reader can be produced at a lower cost than is the case when gold is used for the contact layer.

In one embodiment, the multielement material has a composition of at least one of a carbide or nitride described by the formula Mₙ₊₁AXₙ, where M is a transition metal or a combination of transition metals, A is a group A element or a combination of group A elements, X is carbon or nitrogen or both, and n is 1, 2, 3 or higher, and the multielement material further comprises at least one nanocomposite (4) comprising single elements, binary phases, ternary phases, quaternary phases or higher order phases based on the atomic elements in the corresponding Mₙ₊₁AXₙ compound. These particular forms of the multielement materials of the invention have been shown to have very good properties in view of wear resistance and electrical contact.

The nanocomposite preferably comprises at least two phases chosen from the group consisting of M-A, A-X, M-A-X, X and M-X. In this manner, the contact layer becomes particularly shock resistant and gives a particularly low contact resistance.

In one embodiment of the invention, the transition metal is titanium, X is carbon and the group A element is at least one of silicon, germanium or tin. With such a multielement material a very low contact resistance is achieved, while at the same time the wear resistance is very high.

According to a preferred embodiment of the present invention, the multielement material Ti₃SiC₂ and the nanocomposite comprises at least one phase chosen from the group consisting of Ti—C, Si—C, Ti—Si—C, Ti—Si and C.

The nanocomposite may be at least partially in an amorphous state or a nanocrystalline state, and can have amorphous regions mixed with nanocrystalline regions.

### BRIEF DESCRIPTION OF THE DRAWINGS

The invention will be described in more detail with reference to the appended schematic drawings, which show examples of presently preferred embodiments of the invention.

FIG. 1 is a top view of a smart card according to the present invention in the form of a credit card.

FIG. 2a is a schematic view of the structure of a multielement material layer having nanocomposites with nanocrystals mixed with amorphous regions.

FIG. 2b is a schematic view of another structure of a multielement material layer having nanocrystals with nanocrystalline and amorphous layers, mixed with amorphous regions.

FIG. 2c is a schematic view of another structure of a multielement material layer with regions in a nanocrystalline state.

FIG. 3 is a schematic perspective view of a reader according to the present invention.

FIG. 4 is a schematic view of a multielement layer and a metallic layer, FIG. 5 is a schematic view of a multielement material laminated with metallic layers in a repeated structure.

### DETAILED DESCRIPTION OF PREFERRED EMBODIMENTS OF THE INVENTION

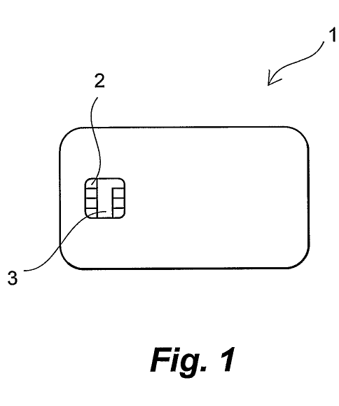

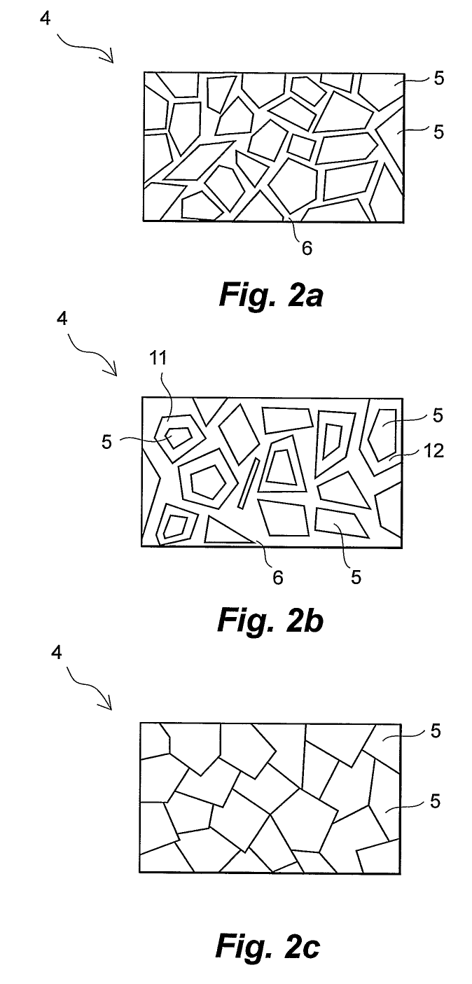

The smart card 1 in FIG. 1 has a chip 2, which has a contact surface 3 coated by a contact layer of a multielement material which has a composition given by the general formula Mₙ₊₁AXₙ and which further contains a nanocomposite 4 (see FIG. 2) comprising single elements, binary phases, ternary phases, quaternary phases or higher order phases based on the atomic elements in the corresponding Mₙ₊₁AXₙ compound. Even if the multielement is based on a composition given by the formula Mₙ₊₁AXₙ, the proportions of the different elements may vary, such that Mₙ₊₁ and Xₙ vary from 1/10 up to 2 times of what the general formula specifies. Just as examples, the composition may be M_{0.2}AX, M_{0.2}AX_{0.1}, M₄AX, or M₂AX₂, thus corresponding to the more general formula M_{q}A_{y}X_{z}, where q, y and z are numbers above zero.

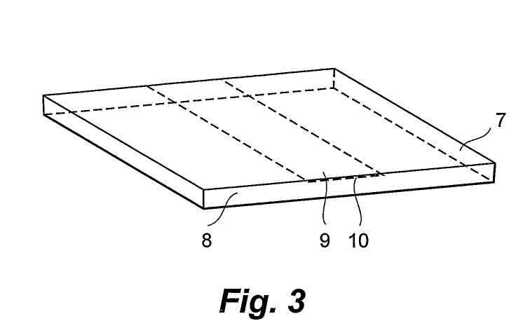

FIG. 3 shows a reader 7 for reading the smart card 1 of FIG. 1. The reader 7 has a slot 8 into which the smart card 1 is inserted for reading. When the smart card 1 is inserted in the slot 8, the chip 2 is brought into contact with the contact element 9 of the reader. Just like the chip 2 of the smart card 1, the contact element 9 of the reader 7 has a contact surface 10 with a contact layer of a multielement material which is described as Mₙ₊₁AXₙ and which further contains a nanocomposite 4 comprising single elements, binary phases, ternary phases, quaternary phases or higher order phases based on the atomic elements in the corresponding Mₙ₊₁AXₙ compound. Just as in the case of the smart card, the composition of the multielement may vary, such that it corresponds rather to the general formula M_{q}A_{y}X_{z}, where q, y and z are numbers above zero.

It has recently been found that compounds with the general formula Mₙ₊₁AXₙ have very good mechanical and electrical properties. In these compounds M is a transition metal or a combination of transition metals, A is a group A element or a combination of group A elements, X is carbon or nitrogen or a combination of the two, and n is 1, 2, 3 or higher. Group A elements are aluminium, silicon, phosphor, sulphur, gallium, germanium, arsenic, cadmium, indium, tin, thallium and lead. Transition metals are scandium, titanium, vanadium, chromium, zirconium, niobium, molybdenum, hafnium and tantalum.

Mₙ₊₁AXₙ compounds are characterised by the number of transition metal layers separating the group A element layers. So called 211 compounds have two transition metal layers, 312 compounds have three transition metal layers and 413 compounds have four transition metal layers. Examples of 211 compounds, which are the most common, are Ti₂AlC, Ti₂AlN, Hf₂PbC, Nb₂AlC, (NbTi)₂AlC, Ti₂AlN_{0.5}C_{0.5}, Ti₂GeC, Zr₂SnC, Ta₂GaC, Hf₂SnC, Ti₂SnC, Nb₂SnC, Zr₂PbC and Ti₂PbC. Only three 312 compounds are known, and these are Ti₃AlC₂ Ti₃GeC₂ and Ti₃SiC₂. Two 413 compounds are known, namely Ti₄AlN₃ and Ti₄SiC₃.

The Mₙ₊₁AXₙ compounds can be in ternary, quaternary or higher phases. Ternary phases have three elements, for example Ti₃SiC₂, quaternary phases have four elements, for example Ti₂AlN_{0.5}C_{0.5}, etc. Elastically, thermally, chemically, electrically the higher phases share many attributes of the binary phases.

Studies of Mₙ₊₁AXₙ compounds include “The Mₙ₊₁AXₙ Phases: A new class of Solids”, Barsoum, Progressive Solid State Chemistry, vol. 28, pp 201-281, 2000, “Magnetron sputtered epitaxial single-phase Ti₃SiC₂ thin films, Palmquist et al., Applied Physics Letters, 2002.81: p. 835, and “Structural characterization of epitaxial Ti3SiC2 film”, Seppänen et al., Proc. 53^{rd} Annual Meeting of the Scandinavian Society for Electron Microscopy, Tampere, Finland, 12-15 June, 2002 Ed. J. Keränen and K. Sillanpää, University of Tampere, Finland, ISSN 1455-4518, 2002), pp. 142-143.

In an embodiment, of the smart card 1 as well as the reader 7, the multielement material of the contact layer is Ti₃SiC₂ and the nanocomposite 4 contains nanocrystals 5 of Ti—C, Si—C, Ti—Si—C, Ti—Si and C. The individual amounts of each phase may vary from one application to another, and not all of these phases are necessarily present in each case.

The multielement material of the contact layer may also have a different composition. For instance, there may be more than one group A element and there may be both carbon and nitrogen in the Mₙ₊₁AXₙ compound. One example of another preferred multielement material is Ti₃Si_{0.5}Sn_{0.5}C₂. The combination of tin and silicon is advantageous, since tin alone may make the contact layer too hydroscopic and silicon alone may oxidise such that an isolating oxide is formed on the chip 2.

In an embodiment, the multielement material has a structure according to FIG. 2a, comprising a nanocomposite 4 made up of nanocrystals 5 mixed with amorphous regions 6. The nanocrystals 5 may all be of the same phase or of different phases.

In an alternative embodiment, the multielement material has a structure according to FIG. 2b, comprising a nanocomposite 4 made up of amorphous regions 6 mixed with nanocrystals 5 of which some are surrounded by amorphous layers 11 or nanocrystalline layers 12.

In yet another alternative embodiment, the multielement material has a structure according to FIG. 2c, comprising a nanocomposite 4 made up of nanocrystalline regions 5.

The thickness of the contact layer is preferably within the range of 0.001 μm to 1,000 μm and the friction is generally very low, normally 0.01 to 0.1.

In other embodiments, the nanocrystals may be coated by a thin film consisting of another phase.

The distribution between nanocrystals and amorphous regions may be different than exemplified above. The nanocomposite may be more or less entirely crystalline or more or less entirely amorphous.

The contact layer is preferably deposited on the chip 2 by physical vapour deposition (PVD) or chemical vapour deposition (CVD), e.g. using the method described in Applicant's WO 04/044263. The contact layer may also be deposited electrochemically, by electroless deposition or by plasma spraying. It is also conceivable to form a separate film of the multielement material and the nanocomposite and to apply this film on the chip 2 of the smart card 1 or the contact element 9 of the reader 7.

The nanocomposite may comprise at least one M-X and M-A-X nanocrystal and amorphous regions with at least one of the M, A and X elements in one or more phases, e.g. M-A, A-X, M-A-X or X.

In one embodiment, the nanocomposite comprises individual regions of single elements, binary phases, ternary phases or higher order phases of carbide and nitride.

The nanocomposite may also be a combination of different Mₙ₊₁AXₙ phases.

The contact layer is preferably continuous over the entire contact element 2, 9, but may also be discontinuous.

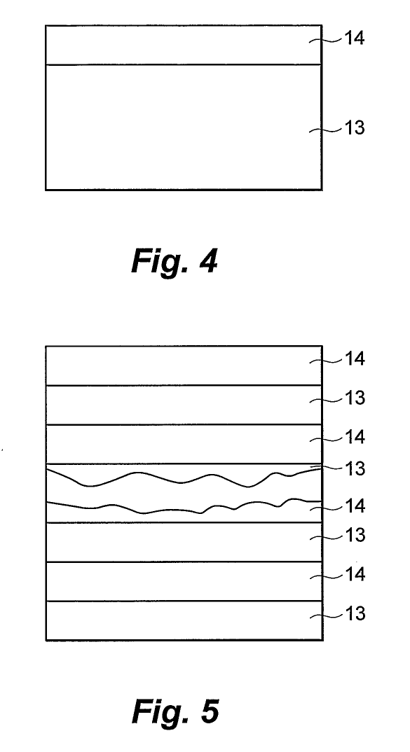

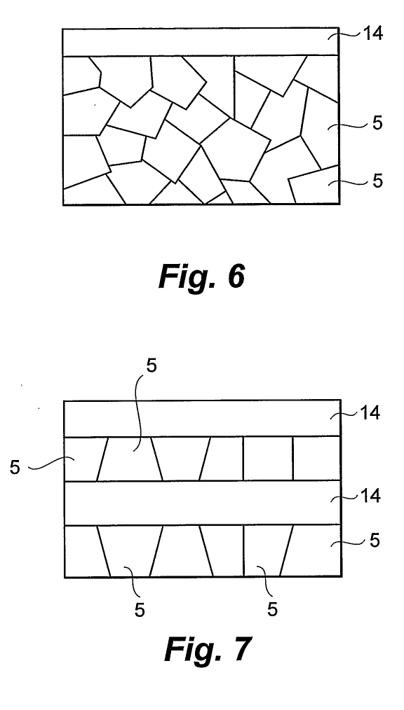

In an embodiment, the multielement material 13 of the contact layer may be coated with a thin metal layer 14, as illustrated by FIG. 4. Preferably the metal layer is provided such that the surface of the contact layer is metallic.

In another embodiment, the contact layer may be a sandwich construction with alternating metal layers 14 and multielement layers 13, as illustrated by FIG. 5, i.e. the multielement layer is laminated with metal layers in a multilayer structure, typically in a repeated structure as shown in the figure.

In yet another embodiment, the multielement layer may comprise regions in a nanocrystalline state 5 and may be coated with a thin metal layer 14, as illustrated in FIG. 6

In yet another embodiment, the multielement layer may comprise regions in a nanocrystalline state and the multielement layer may be laminated with metallic layers in a repeated structure, as shown in FIG. 7.

The metal is preferably gold, silver, palladium, platinum, rhodium, iridium, rhenium, molybdenum, tungsten, nickel or an alloy with at least one of these metals, but other metals may also be useful.

In other embodiments, metallic layers may be used, i.e. a layer that is not necessarily a “pure” metal. Metallic layers of interest include metal composites, where the composite can be an oxide, carbide, nitride or boride. The composite may comprise a polymer, an organic material or a ceramic material such as an oxide, carbide, nitride-or boride.

It is also possible to use an alloy of the multielement material comprising M, A and X elements and one or more metals. The alloyed material may be completely dissolved or may be present in the form of precipitates. The metal used should be a non-carbideforming metal. Preferably, 0-30% metal is added.

The thickness of a metallic layer of the above type, i.e. including metal layers, is preferably in the range of a fraction of an atomic layer to 1000 um, preferably in the range of a fraction of an atomic layer to 5 um. For example, the range may be from 1 nm to 1000 um.

An above mentioned metallic layer may cover grains or regions of the multielement material. The total thickness of a combination of metallic layer(s) and layer(s) of multielement material is typically in the range 0.0001 um to 1000 um.

The multielement material may contain a surplus of carbon, such as in the form of a compound with the formula Tiₙ₊₁SiCₙ+Cₘ. The free carbon elements are transported to the surface of the contact layer and improve electrical contact, while at the same time protecting the surface against oxidation.

Similar kinds of doping of the contact layer for improvement of properties such as friction, thermal properties, mechanical and/or electrical properties, may involve one or a combination of compounds any of a list: a single group A element, a combination of group A elements, X is carbon, X is nitrogen, X is both carbon and nitrogen, a nanocomposite of M-X, nanocrystals and/or amorphous regions with M, A, X elements in one or several phases, such as M-A, A-X, M-A-X.

In an embodiment, the contact layer comprises at least one single element M, A, X in the corresponding Mₙ₊₁AXₙ compound within a range of 0-50% by weight.

The multielement material with nanocomposites may also be used in other applications, e.g. as a coating for reed switches.

1. A smart card having a card contact element for establishing an electrical contact with a reader contact element of a smart card reader for reading the smart card, said card contact element having a contact surface coated with a contact layer, said contact surface being arranged to be brought into contact with the reader contact element, wherein the contact layer comprises a multielement material,
wherein the multielement material has a composition of at least one of a carbide or nitride described by the formula M_{q}A_{y}X_{z}, where M is a transition metal or a combination of transition metals, A is a group A element or a combination of group A elements, X is carbon or nitrogen or both, and q, y and z are numbers above zero, and that the multielement material. Further comprises at least one nanocomposite comprising single elements, binary phases, ternary phases, quaternary phases or higher order phases based on the atomic elements in the corresponding M_{q}A_{y}X_{z} compound.

2. A smart card as claimed in claim 1, wherein the multielement material has a composition of at least one of a carbide or nitride described by the formula Mₙ₊₁AXₙ, where M is a transition metal or a combination of transition metals, A is a group A element or a combination of group A elements, X is carbon or nitrogen or both, and n is 1, 2, 3 or higher, and that the multielement material further comprises at least one nanocomposite comprising single elements, binary phases, ternary phases, quaternary phases or higher order phases based on the atomic elements in the corresponding Mₙ₊₁AXₙ compound.

3. A smart card as claimed in claim 1, wherein the nanocomposite comprises at least two phases chosen from the group consisting of M-A, A-X, M-A-X, X and M-X.

4. A smart card as claimed in claim 1, wherein the transition metal is titanium, X is carbon and the group A element is at least one of silicon, germanium or tin.

5. A smart card as claimed in claim 1, wherein the multielement material is Ti₃SiC₂ and the nanocomposite comprises at least one phase chosen from the group consisting of Ti—C, Si—C, Ti—Si—C, Ti—Si and C.

6. A smart card as claimed in claim 1 the preceding claims, wherein the nanocomposite is at least partially in an amorphous state.

7. A smart card as claimed in claim 1, wherein, the nanocomposite is at least partially in a nanocrystalline state.

8. A smart card as claimed in claim 1, wherein the nanocomposite has amorphous regions mixed with nanocrystalline regions.

9. A smart card as claimed in claim 1, wherein the contact layer comprises a metallic layer.

10. A smart card as claimed in claim 9, wherein the metallic layer is any of Au, Ag, Pd, Pt, Rh, Ir, Re, Mo, W, Ni or an alloy with at least one of any of the aforementioned-metals.

11. A smart card as clamed in claim 9, wherein the metallic layer is any metal or metal composite where the composite can be an oxide, carbide, nitride or boride.

12. A smart card as claimed in claim 9, wherein the metallic layer is any metal or metal-composite, the composite comprising a polymer, an organic material or a ceramic material such as an oxide, carbide, nitride or boride.

13. A smart card as claimed in claim 9, wherein the multielement material is laminated with metallic layers in a multilayer structure.

14. A smart card as claimed in claim 8, wherein the multielement material has a coat of the metallic layer such that the contact surface is metallic.

15. A smart card as claimed in claim 1, wherein the contact layer is doped by one or several compounds or elements for altering and improving friction, mechanical, thermal and electrical properties of the contact layer.

16. A smart card as claimed in claim 1, wherein the contact layer comprises at least one single element M, A, X in the corresponding Mₙ₊₁AXₙ compound within a range of 0-50% by weight.

17. A reader for reading a smart card, said reader having a reader contact element for establishing an electrical contact with a card contact element on a smart card, said reader contact element having a contact surface coated with a contact layer, said contact surface being arranged to be brought into contact with the card contact element, wherein the contact layer comprises a multielement material, wherein the multielement material has a composition of at least one of a carbide or nitride described by the formula M_{q}A_{y}X_{z}, where M is a transition metal or a combination of transition metals, A is a group A element or a combination of group A elements, X is carbon or nitrogen or both, and q, y and z are numbers above zero, and that the multielement material further comprises at least one nanocomposite comprising single elements, binary phases, ternary phases, quaternary phases or higher order phases based on the atomic elements in the corresponding Mₙ₊₁AXₙ compound.

18. A reader as claimed in claim 17, wherein the multielement material has a composition of at least one, of a carbide or nitride described by the formula Mₙ₊₁AXₙ, where M is a transition metal—or a combination of transition metals, A is a group A element or a combination of group A elements, X is carbon or nitrogen or both, and n is 1, 2, 3 or higher, and that the multielement material further comprises at least one nanocomposite comprising single elements, binary phases, ternary phases, quaternary phases or higher order phases based on the atomic elements in the corresponding Mₙ₊₁AXₙ compound.

19. A smart card reader as claimed in claim 17, wherein the nanocomposite comprises at least two phases chosen from the group consisting of M -A, A-X, M-A-X, X and M-X.

20. A smart card reader as claimed in claim 17, wherein the transition metal is titanium, X is carbon and the group A element is at least one of silicon, germanium or tin.

21. A smart card reader as claimed in claim 17, wherein the multielement material is Ti₃SiC₂ and the nanocomposite comprises at least one phase chosen from the group consisting of Ti—C, Si—C, Ti—Si—C, Ti—Si and C.

22. A smart card reader as claimed in claim 17, wherein the nanocomposite is at least partially in an amorphous state.

23. A smart card reader as claimed in claim 17, wherein the nanocomposite is at least partially in a nanocrystalline state.

24. A smart card reader as claimed in claim 17, wherein the nanocomposite has amorphous regions mixed with nanocrystalline regions.
